(19) United States
(12) Patent Application Publication
(10) Pub. No.: US 2025/0017398 A1
(43) Pub. Date: Jan. 16, 2025

(54) WARMING BLANKET

(71) Applicant: Graham WILLIAMS, Portland, OR (US)

(72) Inventor: Graham WILLIAMS, Portland, OR (US)

(21) Appl. No.: 18/770,267

(22) Filed: Jul. 11, 2024

Related U.S. Application Data
(60) Provisional application No. 63/513,524, filed on Jul. 13, 2023.

(51) Int. Cl. A47G 9/02; B32B 7/12; B32B 15/04; B32B 15/14; H05B 3/04; H05B 3/14; H05B 3/34

(52) U.S. Cl. CPC A47G 9/0215; A47G 9/0223; B32B 7/12; B32B 15/043; B32B 15/14; H05B 3/04; H05B 3/145; H05B 3/342; B32B 2250/05; B32B 2262/106; B32B 2305/345; B32B 2307/202; B32B 2307/206; B32B 2307/7265; B32B 2307/7376; B32B 2457/00; H05B 2203/016

(57) ABSTRACT

A warming blanket that includes a carbon fibre layer.

### CROSS REFERENCE TO RELATED APPLICATIONS

This application claims benefit of U.S. Provisional Patent Application No. 63/513,524 filed Jul. 13, 2023.

### BACKGROUND

The subject matter of this application relates to a warming blanket.

Surgical patients under anaesthesia may become poikilothermic. In such cases, patients may lose their ability to control their body temperature and can take on or lose heat depending on the temperature of the environment. Since modern operating rooms are typically air conditioned to a relatively low temperature and optimized for surgeon comfort, patients undergoing general anaesthesia may lose heat and become clinically hypothermic if not warmed.

Beyond concerns of modern operating rooms, hypothermia is a leading cause of death in trauma patients. Victims of trauma commonly experience hypothermia, especially when aggravated by traumatic haemorrhage, which leads to hypovolemic shock. The risk of hypothermia is increased in pre-hospital settings, from initial response to transport of the patient and medical procedures such as infusions and airway management.

In other situations, a wounded soldier may experience difficulty in their ability to control their body temperature, especially in an artic environment where it is cold. The heat loss as a result may cause the wounded soldier becoming hypothermic.

Electric warming blankets have been used to warm patients during surgery and other environments to reduce the likelihood of the patient to become hypothermic. The heating blankets may be made of multiple layers of materials including fabrics, plastic film, and fibrous non-woven materials. The multiple layers may be bonded together into laminated structures. The multiple layer laminated structure may result in blankets that may not offer adequate flexibility. Such heating blankets may not naturally drape over the patient and may not make good contact with the patient's sides to maximize the surface area available for conductive heat transfer. Also, such multiple layer laminated structure may not be sufficiently robust for harsh environments. Moreover, the power requirements for the operation of such blankets may be more than can be readily supplied by a portable low-weight battery, for when the blanket is being used in a remote environment.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a heating blanket.

FIG. 2 illustrates multi-layered construction of the heating blanket.

FIG. 3 illustrates a carbon fibre arrangement.

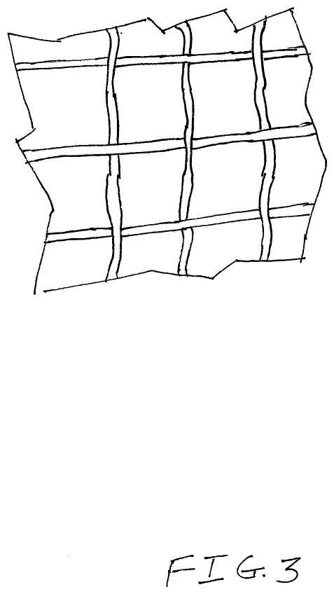

FIG. 4 illustrates bus bars with the heating blanket.

### DETAILED DESCRIPTION

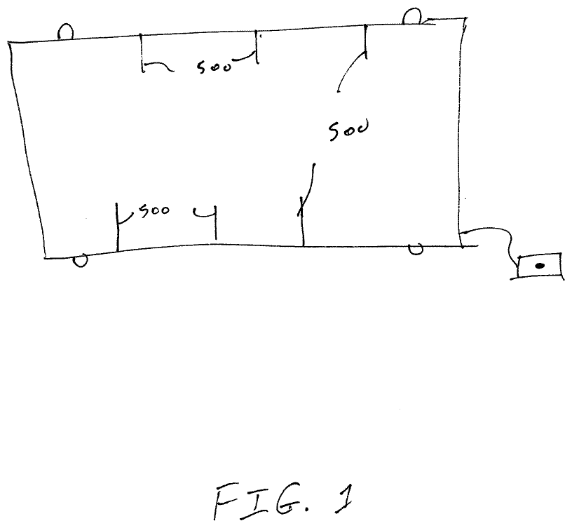

Referring to FIG. 1, an exemplary heating blanket 100 is illustrated. The heating blanket 100 is preferably generally rectangular in shape. However, the shape of the heating blanket 100 is not limiting and the heating blanket 100 can be formed into any shape. The heating blanket may include a hood for the patient's head. The heating blanket may include a heating element. The heating element may have elastic properties and can be disposed in the shape of a sheet. The heating element may be coupled to electrical terminals to supply power to the heaving element. The heating element may have electrical resistance, which can be related to the heat generated by the heating element by the following relationship: Q=I2×R, wherein Q indicates the heat generated in Joules, I indicates the current through the heating element in Amperes, and R indicates the electrical resistance of the heating element in Ohms.

Electrical wires arranged in some type of pattern have traditionally been used as the heating elements within heating blankets because of their electrical conductivity, their electrical resistance, and their flexibility. With power applied to the electrical wires, the wires heat up, which in turns heats up the patient. However, it was determined that simply primary heating of the electrical wires to provide heat to the patient has limited extended use with portable battery powered power sources. After further consideration it was determined that a heating element that includes a more substantial amount of electromagnetic radiation in the short and/or medium and/or long infrared spectrum provides for improved heating of the patient in a controlled manner. By way of example, the short infrared spectrum may include 780-1,400 nm. By way of example, the medium infrared spectrum may include 1,400-3,000 nm. By way of example, a portion of the long infrared spectrum may include 3,000-12,000 nm (long infrared spectrum being from 3,000-1,000,000 nm).

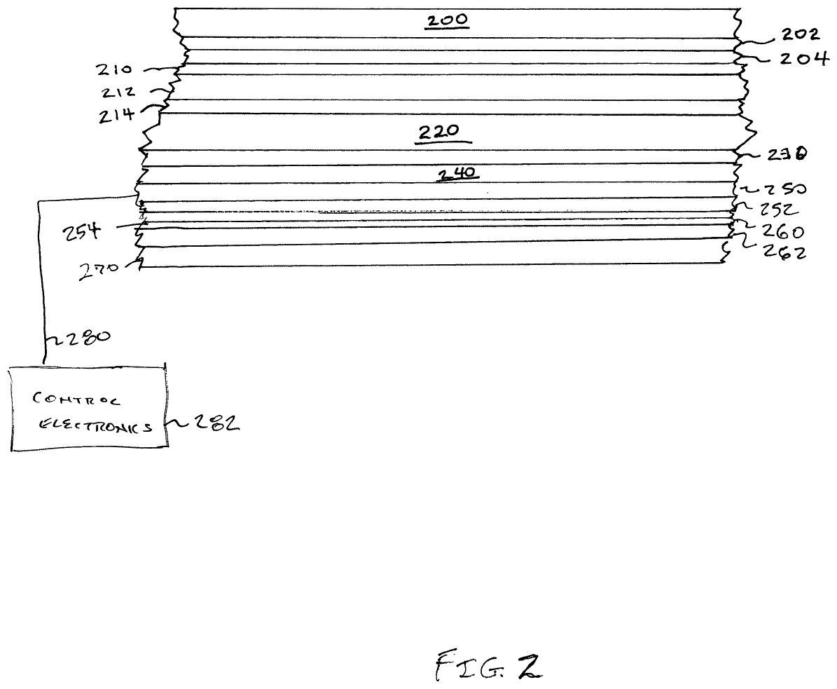

Referring to FIG. 2, the heating blanket 100 may be constructed from a multi-layered construction. An outer layer 200 is preferably a fabric material. By way of example, the fabric material may be a nylon, a polyolefin, a woven material, a non-woven material, a flashbond, spunbond or spunbond meltblown spunbond (e.g., Tyvek®), or any other type of material. The outer layer 200 provides a protective layer for the heating blanket 100 and is often suitable for having a pattern printed thereon. Preferably, the outer layer 200 is water resistant to repel liquids from being absorbed by the heating blanket 100.

The multi-layered construction of the heating blanket 100 preferably includes a first adhesive layer 202. The first adhesive layer 202 may be applied as a film and/or a liquid. The first adhesive layer 202 also provides thermal insulation and electrical insulation. The first adhesive layer 202 preferably has thermo-insulator properties to bond to the outer layer 200 and the next layer in the multi-layered construction of the heating blanket 100. The first adhesive layer 202 is preferably between 0.125 mils and 0.50 mils thick.

The multi-layered construction of the heating blanket 100 preferably includes a first metal layer 204. The first metal layer 204 is preferably a relatively thin metal film that has a thickness between 0.125 mils to 2.00 mils (thousandth of an inch). The first metal layer 204 provides thermal insulation and reflectivity of energy to the patient. The first metal layer 204 is preferably generally porous in nature. The first metal layer preferably has an optical density from 0.18 to 2.5. The first metal layer is preferably selected such that it is substantially reflective to infrared energy, so that such energy directed outwardly may be reflected toward the patient for improved heating.

If desired, the outer layer 200, the adhesive layer 202, and the first metal layer 204 may be heated and/or pressed together to form a unitary structure.

The multi-layered construction of the heating blanket 100 preferably includes a second adhesive layer 210. The second adhesive layer 210 may be applied as a film and/or a liquid. The second adhesive layer 202 also provides thermal insulation and electrical insulation. The second adhesive layer 202 preferably has thermo-insulator properties to bond to the first metal layer 204 and the next layer in the multi-layered construction of the heating blanket 100. The second adhesive layer 214 is preferably between 0.5 mils and 5 mils thick.

The multi-layered construction of the heating blanket 100 preferably includes a second metal layer 212. The second metal layer 212 is preferably a relatively thin metal film that has a thickness between 0.5 mils to 5.00 mils (thousandth of an inch). The second metal layer 212 provides thermal insulation and reflectivity of energy to the patient. The second metal layer 212 is preferably generally porous in nature. The second metal layer 212 preferably provides optical density of 1.8 to 4.5. If desired, the outer layer 200, the adhesive layer 202, the first metal layer 204, the second adhesive layer 210, and the second metal layer 212, may be heated and/or pressed together to form a unitary structure. The second metal layer is preferably selected such that it is substantially reflective to infrared energy, so that such energy directed outwardly may be reflected toward the patient for improved heating. The second metal layer 212 is preferably selected to be twice or more the thickness of the first metal layer 204. The greater thickness of the second metal layer 212 provides for improved reflectivity of infrared energy while maintaining reasonable flexibility, while the thinner thickness of the first metal layer 204 provides for lesser reflectivity of infrared energy while maintaining greater flexibility. In this manner, the thermal properties of the heating blanket 100 may be achieved, while maintaining reasonable overall flexibility. By way of example, the second metal layer 204 may be BoPET (biaxially oriented polyethylene terephthalate) and/or LDPE (low density polyethylene). The second metal layer 212 may include a first metal on a first side and a second metal on a second side. In this manner, the metal may be optimized for the performance desired. For example, the outwardly facing layer of the second metal layer 212 may be aluminium while the inwardly facing layer of the second metal layer 212 may be copper, gold, and/or silver. Aluminium has a lower reflectance in a lower portion of the infrared spectrum than copper (and gold and silver).

The multi-layered construction of the heating blanket 100 preferably includes a third adhesive layer 214. The third adhesive layer 214 may be applied as a film and/or a liquid. The third adhesive layer 214 also provides thermal insulation and electrical insulation. The third adhesive layer 214 preferably has thermo-insulator properties to bond to the second metal layer 212 and the next layer in the multi-layered construction of the heating blanket 100. The third adhesive layer 214 is preferably between 0.25 mils and 8 mils thick.

The multi-layered construction of the heating blanket 100 preferably includes a carbon fibre layer 220. The carbon fibre layer 220 is preferably constructed from 1K (1,000) and/or 2K (2,000) carbon filaments, or “tows”, that are bundled together, which may include any suitable weave. The carbon fibre layer is preferably constructed from a tape like product that is relatively thin and relatively wide in comparison to its thickness. The carbon fibre is preferably arranged in a pattern that includes a substantial number of cross-over points where the carbon fibre tape sections come into contact with one another. Carbon fibres are generally fibres about 5 to 10 micro-meters (0.00020-0.00039 in) in diameter and composed mostly of carbon atoms. The carbon fibre layer is preferably an interconnected wide spaced 0:90 and 30:−30 degree pattern. The total resistance of the carbon fibre layer is preferably between 6 and 15 ohms. Alternately, the carbon fibre layer can consist of a spunbond veil of nondirectional fibres.

The multi-layered construction of the heating blanket 100 preferably includes a fourth adhesive layer 230. The fourth adhesive layer 230 may be applied as a film and/or a liquid. The fourth adhesive layer 230 also provides electrical insulation. The fourth adhesive layer 230 preferably has thermo-insulator properties sufficient to bond to the carbon fibre layer 220 when heated and the next layer in the multi-layered construction of the heating blanket 100. The fourth adhesive layer 230 preferably has a higher specific heat than the adhesives used previously. The fourth adhesive layer 230 is preferably between 0.125 mils and 0.5 mils thick.

As it may be observed, the third adhesive layer 214 and the fourth adhesive layer 230 sandwich the carbon fibre layer 220. With sufficient bonding by heat and/or pressure of the adhesives 214, 230 with the carbon fibre layer 220, the carbon fibre tape is sufficiently maintained in a face-to-face arrangement with one another at their cross-over points. In this manner, the resulting arrangement of the carbon fibre tape acts as more in a manner of a single pattern of interconnected carbon fibre material. Also, the adhesives 214, 230 maintain the carbon fibre layer 220 in a stable predefined arrangement.

Power, primarily in the form of current, is applied to the carbon fibre layer which results in the generation of thermal energy by the carbon fibre material. Carbon fibre material has substantial emission of energy in the infrared spectrum. With substantial emission of energy in the infrared spectrum the patient is effectively maintained warm, without excessive heating of the heating blanket.

The multi-layered construction of the heating blanket 100 preferably includes a conductive layer 240. The conductive layer includes one or more conductors that are electrically interconnected to one or more locations on the carbon fibre layer 220. By way of example, the conductive layer 240 may be a conductive pattern of wires that interconnect to various locations of the carbon fibre material. By way of example, the conductive layer 240 may be include in the carbon fibre layer 220. By way of example, the conductive layer 240 may be included as wires included within fabric yarns. By way of example, the conductive layer 240 may be included as metalized fibres.

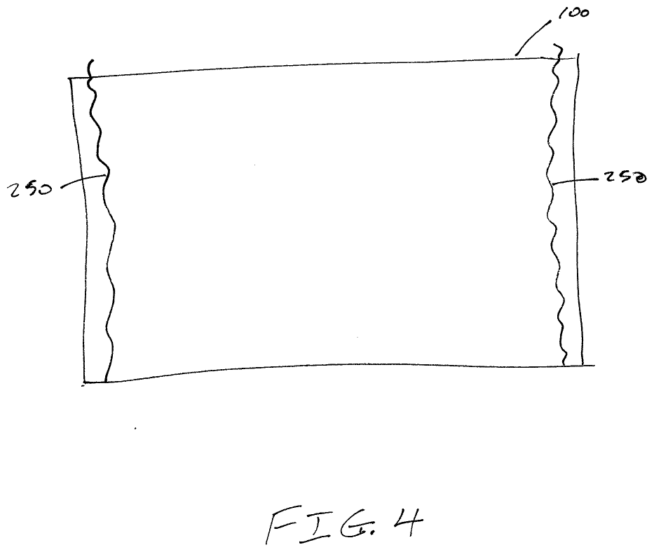

Referring also to FIG. 4, in addition to, or alternative to, the conductive layer 240, one or more conductive busses 250 (shown exposed) may be provided along one or more respective edge portions of the heating blanket 100. By way of example, the conductive busses 250 may interconnect directly to the carbon fibre layer 220 or otherwise to the conductive layer 230, which in turn interconnects to the carbon fibre layer 220. In this manner, electrical energy is transferred to the carbon fibre layer 220 to provide thermal energy. Preferably, for an elongate heating blanket that is rectangular in shape, a conductive bus 250 is included along the upper portion of the heating blanket (e.g., short side of the rectangular heating blanket) and a conducive bus 250 is included along the lower portion of the heating blanket (e.g., short side of the rectangular heating blanket).

The multi-layered construction of the heating blanket 100 preferably includes a fifth adhesive layer 252. The fifth adhesive layer 252 may be applied as a film and/or a liquid. The fifth adhesive layer 252 also provides thermal insulation and electrical insulation. The fifth adhesive layer 252 preferably has thermo-insulator properties to bond to the conductive busses 250 and/or the conductive layer 240 and the next layer in the multi-layered construction of the heating blanket 100. The fifth adhesive layer 252 is preferably between 0.125 mils and 2.0 mils thick.

The multi-layered construction of the heating blanket 100 preferably includes a highly water resistant, electrically insulating film layer 254. The film 254 encapsulates and isolates the electrical components from the patient and any fluids. The film 254 preferably is infrared transmissive in a range of 60% to 99%. The film 254 may be white or uncoloured, but is preferably black. The film 254 may be from 2 mil to 4 mil in thickness.

The multi-layered construction of the heating blanket 100 preferably includes a temperature sensor(s) layer 260. The temperature sensors are preferably distributed across the heating blanket 100 in a generally uniform pattern. The temperature sensors may sense the temperature of the heating blanket 100 and/or the temperature of the patient. In this manner, control electronics for the heating blanket 100 may control the power provided to the heating blanket 100 to adjust its temperature higher and/or lower.

The multi-layered construction of the heating blanket 100 preferably includes a sixth adhesive layer 260. The sixth adhesive layer 260 may be applied as a film and/or a liquid. The sixth adhesive layer 260 also provides thermal insulation and electrical insulation. The sixth adhesive layer 260 preferably has thermo-insulator properties to bond to the conductive busses 250 and/or the conductive layer 240 and/or the temperature sensor(s) 260 and the next layer in the multi-layered construction of the heating blanket 100. The sixth adhesive layer 260 is preferably between 2 mils and 25 mils thick.

The multi-layered construction of the heating blanket 100 preferably includes an inner layer 270 is preferably a fabric material or a paper material. By way of example, the fabric material may be a nylon, a polyolefin, a woven material, a non-woven material, a spunbond (e.g., Tyvek®), or any other type of material. Preferably, the material is a paper-based material that is absorbent of liquids. Alternately, a paper-based material that is absorbent of liquids may be affixed to a water resistant yet absorptive outer layer 270. The inner layer 270 provides a protective layer for the heating blanket 100 and is often suitable for having a pattern printed thereon. The inner layer 270 may be water resistant to repel liquids from being absorbed by the heating blanket 100. Preferably, the inner layer 270 is water absorbent to absorb blood and other bodily fluids of the patient. Accordingly, the inner layer 270 is preferably more absorbent to liquids than the outer layer 200.

It is to be understood that many of the adhesive layers may be as a result of the adhesive penetrating a layer therebetween. In this manner, each of the adhesive layers may not need to be individually provided, but otherwise provide adhesion between the different layers.

The multi-layered construction is preferably heated and/or pressed together to form a unitary structure. One or more of the aforementioned layers may be omitted, as desired. One or more of the aforementioned layers may be rearranged, as desired.

Each of the conductive busses 250 may be interconnected with one or more conductors 280 which are interconnected with control electronics 282. Each of the temperature sensors may be interconnected with one or more conductors 280 which are interconnected with the control electronics 282. The control electronics 282 may turn on/off the power to the heating blanket and also control the manner of providing power to the heating blanket. The control electronics 282 preferably provide 12 volts DC to the heating blanket.

There may be vector or buckles affixed to the heating blanket 100 to allow the blanket to be tightly wrapped around the patient.

As illustrated in FIG. 1, the heating blanket may include a plurality of slits 500 so that individual sections of the heating blanket may be wrapped around the patient without causing much movement of the remainder of the heating blanket. Also, with the mesh pattern of the carbon fibre, the slits do not meaningfully impact the ability to generate heat. Further, the heating blanket is suitable for the user to cut additional slits, as needed, to provide a better fit for the heating blanket without meaningfully impacting its operation.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

I/We claim:

1. A warming blanket comprising:
(a) a fabric layer forming an upper outer layer of the warming blanket;
(b) a first adhesive layer having a thickness between 0.125 mils and 0.50 mils;
(c) a first metal layer having a thickness between 0.125 mils and 2.00 mils and an optical density between 0.18 and 2.5;
(d) a second adhesive layer having a thickness between 0.5 mils and 5.0 mils;
(e) a second metal layer having a thickness between 0.5 mils and 5.00 mils and an optical density between 1.8 and 4.5;
(f) a third adhesive layer having a thickness between 0.25 mils and 8.0 mils;
(g) a carbon fiber layer;
(h) a fourth adhesive layer having a thickness between 0.125 mils and 0.5 mils;
(i) a first conductive layer electrically interconnected to one or more locations of the carbon fiber layer;
(j) an electrical connector interconnected to said warming blanket to selectively provide power to said carbon fiber layer to generate thermal energy.

2. The warming blanket of claim 1 further comprising:
(a) a fifth adhesive layer having a thickness between 0.125 mils and 2.0 mils.

3. The warming blanket of claim 2 further comprising:
(a) a water resistant electrically insulating layer.

4. The warming blanket of claim 3 further comprising:
(a) a temperature sensor layer.

5. The warming blanket of claim 4 further comprising:
(a) a fifth adhesive layer having a thickness between 2.0 mils and 25.0 mils.

6. The warming blanket of claim 5 further comprising:
(a) a paper layer forming a lower outer layer of the warming blanket.

7. The warming blanket of claim 1 wherein the fabric layer comprises at least one of a nylon, a polyolefin, a woven material, a non-woven material, a flashbond, a spunbond, a spunbond meltblown spunbond.

8. The warming blanket of claim 1 wherein said fabric layer, said first adhesive layer, and said first metal layer are bonded together to form a unitary structure.

9. The warming blanket of claim 1 wherein said fabric layer, said first adhesive layer, said first metal layer, said second adhesive layer, and said second metal layer, are bonded together to form a unitary structure.

10. The warming blanket of claim 1 wherein said second metal layer is greater than two times the thickness of said first metal layer.

11. The warming blanket of claim 1 wherein said second metal layer comprises at least one of biaxially oriented polyethylene terephthalate and low density polyethylene.

12. The warming blanket of claim 1 wherein said carbon fiber layer has a total resistance between 6 and 15 ohms.
